(19) United States
(12) Patent Application Publication
(10) Pub. No.: US 2022/0363381 A1
(43) Pub. Date: Nov. 17, 2022

(54) An Umanned Aerial Vehicle

(71) Applicant: XDynamics Limited, Hong Kong (HK)

(72) Inventor: Man Wah Chan, Mid-Levels (HK)

(21) Appl. No.: 17/627,646

(22) PCT Filed: Feb. 6, 2020
(86) PCT No.: PCT/CN2020/074421

§ 371 Date: Jan. 15, 2022

(51) Int. Cl. B64C 39/02

(52) U.S. Cl. CPC B64C 39/024; B64C 2201/108; B64C 2201/042

(57) ABSTRACT

The invention relates to an unmanned aerial vehicle (UAV). The UVA comprises a body; and a plurality of propellers supported by said body; the plurality of propellers being arranged spaced apart from one another, with each of the propellers comprising at least one blade rotatable by a respective rotor; the arrangement being such that swept areas of some of said plurality of propellers partially overlap when the propellers are rotating.

### FIELD OF THE INVENTION

The invention relates to a configuration of a drone such as an unmanned aerial vehicle (UAV), and particularly, but not exclusively, to a configuration of a UAV such as a multi-copter.

### BACKGROUND OF THE INVENTION

There has been a rapid development in the field of unmanned vehicles and particularly, in the technology of unmanned aerial vehicles (UAVs) such as multi-copters and drones. A conventional UAV may comprise one or more propellers controlled by a flight control computer having one or more controllers and/or sensors.

A drone or multi-copter is a rotorcraft normally with more than two rotors. An advantage of a multi-rotor aircraft is the simpler rotor mechanics required for flight control. Unlike single- and double-rotor helicopters which typically use complex variable pitch rotors whose pitch varies as the blade rotates for flight stability and control, multi-rotors use fixed-pitch blades. Consequently, control of vehicle motion is achieved by varying the relative speed of each rotor to change the thrust and torque produced by each rotor. Different designs and configurations of the blades of the propellers, including variations in number, size, shape, and pitch angle, for example, are developed so as to facilitate and to enhance performance of a drone. In general, propellers with longer or larger blades are found to produce higher thrust and stability for the flight, but will respond more slowly to user's inputs in relation to flight control and will consume more power due to the greater air drag and weight. Various attributes of the propellers should therefore be carefully considered for matching with the overall configuration of the drone to thereby allow an optimum performance and power efficiency.

### OBJECTS OF THE INVENTION

An object of the present invention is to provide a novel unmanned aerial vehicle such as a multi-copter or drone.

Another object of the present invention is to mitigate or obviate to some degree one or more problems associated with known unmanned aerial vehicles, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

The invention provides an unmanned aerial vehicle (UAV). The UAV comprises a body, and a plurality of propellers supported by said body. The plurality of propellers are arranged spaced apart from one another, with each of the propellers comprising at least one blade rotatable by a respective rotor; the arrangement being such that swept areas of some of said plurality of propellers partially overlap when the propellers are rotating.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a perspective view of a UAV in accordance with an embodiment of the present invention;

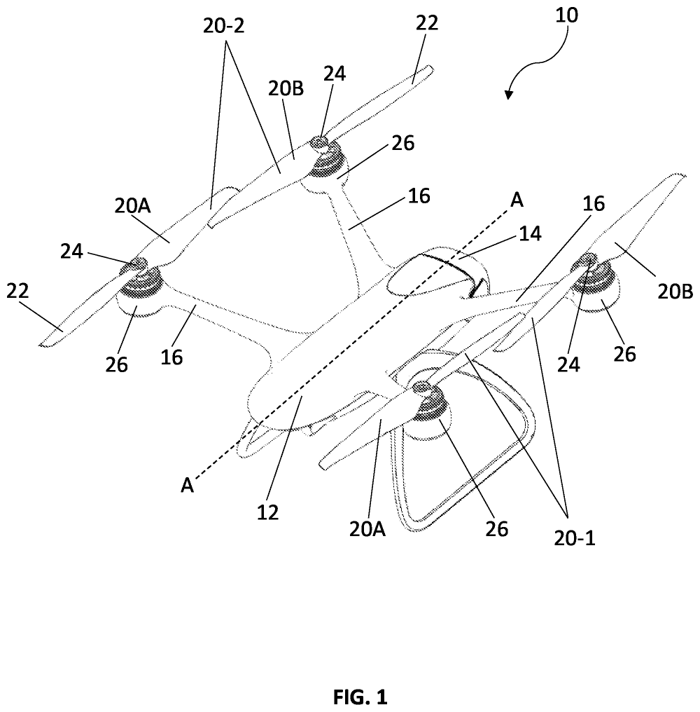

FIG. 2 is a top view of the UAV of FIG. 1;

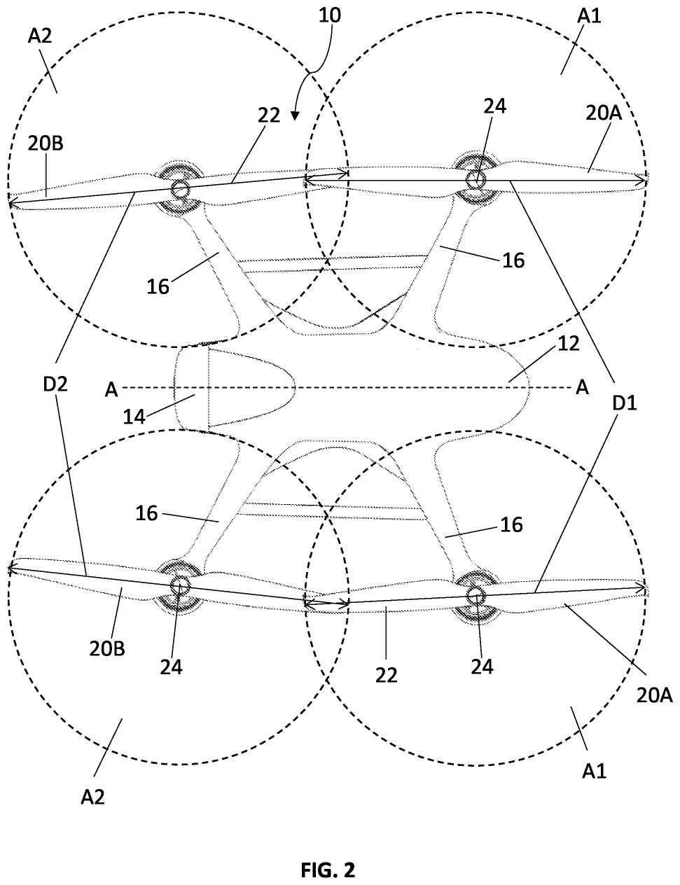

FIG. 3 is a bottom view of the UAV of FIG. 1;

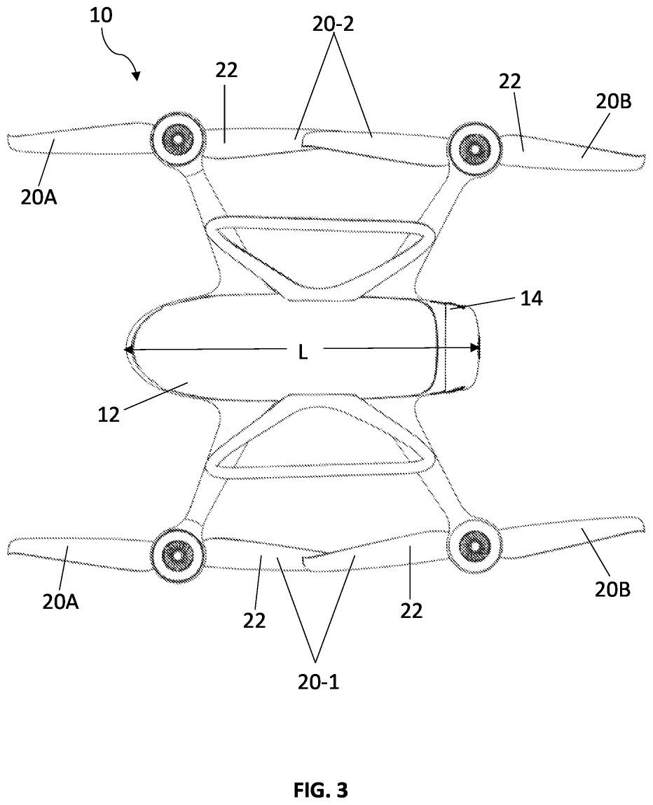

FIG. 4 is a side view of the UAV of FIG. 1; and

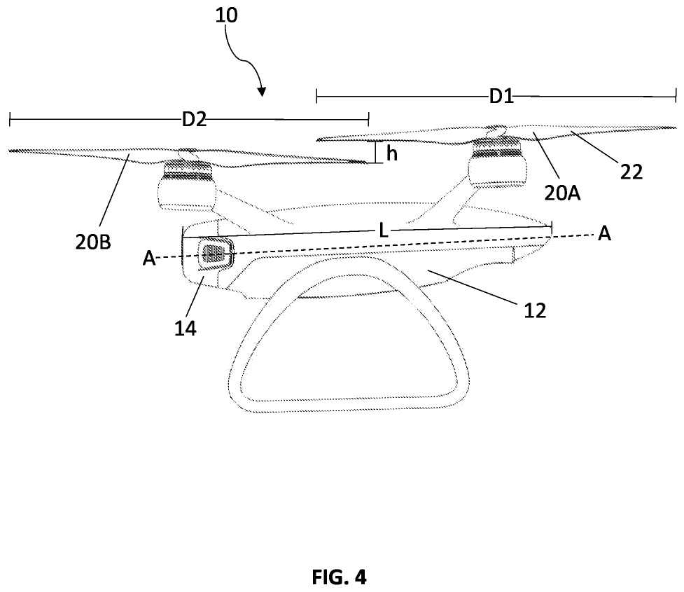

FIG. 5 is a rear view of the UAV of FIG. 1.

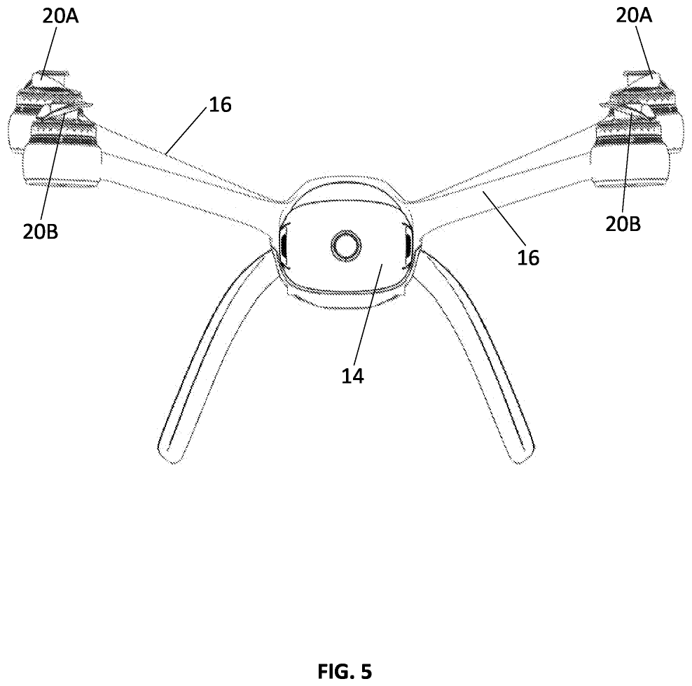

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the following description, embodiments of a drone or multi-copter are described by way of example of an unmanned aerial vehicle (UAV), particularly a small-sized UAV having a weight up to about 40 kg, although this is not a limiting weight size.

Referring to the drawings, there is provided a UAV 10 with a body 12 housing a control system for controlling the UAV 10. The control system (not shown) may generally comprise at least a control circuitry and a wireless communication circuitry powered by a power source 14, which can be a rechargeable battery 14 releasably attachable to the body 12 at is rear end. The UAV 10 can be operable by controlling wirelessly from a ground station (not shown), or it may operate automatically according to preprogrammed control instructions uploaded to its control circuitry. The body 12 is preferably generally elongated in shape with a substantially streamlined exterior which assists in reducing air-resistance during a flight, although it will be understood that the shape of the body of the UAV may take any suitable form.

The UAV 10 is preferred to comprise a plurality of propellers 20, such as but are not limited to, four propellers 20 as shown in the drawings. The four propellers 20 are supported by and are extended outwardly from the body 12 via a plurality of corresponding arms 16. The arms 16 are preferred to be upwardly inclined with respect to a horizontal plane of the UAV body, such that the propellers 20 can be positioned to space away from the body 12 and also from one another thereby reducing interference of air flow by the nearby structural parts of the UAV 10.

In one embodiment, the four propellers 20 may each comprise one or more blades 22 in any known configurations, such as in the form of two linearly connected, elongated blades, as shown in the drawings. The blades 22 can be connected at and are rotatable by a rotor 24 of a respective motor 26 arranged at the end of the arm 16. Particularly, when the rotors 24 are driven to rotation by the respective motors 26, at least part of the blades 22 of two adjacently mounted propellers 20 will be arranged to momentarily overlap, i.e. the areas swept by the blades 22 of two adjacent propellers 20 will be partially overlapped, but of course, there will be no direct physical contact between the blades 22.

The plurality of propellers 20 may comprise a front propeller 20A arranged adjacent to a front end of the UAV 10, and a rear propeller 20B arranged adjacent to a rear end of the UAV 10. Particularly, the front propeller 20A is adapted to define a swept area (A1) having a diameter (D1), and the rear propeller 20B is adapted to define a swept area (A2) having a diameter (D2). More particularly, the swept area (A1) of the front propeller 20A is partially overlapped with the swept area (A2) of the rear propeller 20B when the propellers 20 are set to rotate.

In one embodiment, the diameter (D1) of the swept area (A1) of the front propeller 20A is substantially similar or is identical in length to the diameter (D2) of the swept area (A2) of the rear propeller 20B.

Preferably, the diameter (D1) of the swept area (A1) of the front propeller 20A overlaps the diameter (D2) of the swept area (A2) of the rear propeller 20B by a distance of less than or equal to about 15% of the swept diameter of the propeller 20, such as the diameter (D1) of the swept area (A1) of the front propeller 20A, or the diameter (D2) of the swept area (A2) of the rear propeller 20B. More preferably, the diameter (D1) of the front propeller 20A and the diameter (D2) of the rear propeller 20B are arranged to overlap by a distance of less than 10% of the diameter (D1) of the front propeller 20A, or the diameter (D2) of the rear propeller 20B.

In another embodiment, the two blades 22 at each of the front propeller 20A and the rear propeller 20B are linearly connected at their respective rotors 24, and together, they define the respective swept areas (A1, A2) of the propellers 20A, 20B having respective diameters (D1, D2). In one further embodiment, the body 12 of the UAV 10 is of a longitudinal length (L), i.e. a length along the longitudinal direction, which is substantially equal to or less than the diameter (D1) of the front propeller 20A, or the diameter (2) of the rear propeller 20B. For example, the diameters D1 and D2 may each to be of about 25 cm to about 40 cm, while the body length (L) of the UAV 10 can be of about 20 cm to about 35 cm.

In the embodiment as shown in the drawings, for example, the UAV 10 may comprise a first pair of propellers 20-1 comprising a front propeller 20A and a rear propeller 20B arranged on a first side, such as the left, lateral side of the UAV 10; and a second pair of propellers 20-2 also comprising a front propeller 20A and a rear propeller 20B arranged on a second side, such as the right, lateral side of the UAV 10. The first pair of propellers 20-1 and the second pair of propellers 20-2 are preferably symmetrically arranged about a central longitudinal axis A-A of the body 12, with the rotors 24 of the front propellers 20A of the first and second pairs of propellers 20-1, 20-2 being spaced apart by a distance larger than a distance between the rotors 24 of the rear propellers 20B of the first and second pairs of propellers 20-1, 20-2. In one specific embodiment, the distance between the rotors 24 of the two front propellers 20A of the first and second pairs of propellers 20-1 and 20-2, and the distance between the rotors 24 of the two rear propellers 20B of the first and second pairs of propellers 20-1, 20-2 are preferred to be in a range of ratio between about 10:8 to about 10:9.8. For example, the rotors 24 of the two front propellers 20A can be configured to space apart by about 40 cm, while the rotors 24 of the two rear propellers 20B are arranged to space apart by about 38 cm.

Additionally or alternatively, the rotors 24 of the front propellers 20A of the first and second pairs of propellers 20-1, 20-2 may also be configured to space apart by a distance larger than a distance between the rotors 24 of the front propeller 20A and the rear propeller 20A of the first pair of propellers 20-1, and/or the second pairs of propellers 20-2, for example.

In one embodiment, the swept areas (A1, A2) of the front and rear propellers 20A, 20B of each of the first and second pairs of propellers 20-1, 20-2 are preferred to partially overlap when rotating. However, the swept areas (A1) of the front propellers 20A of the first and second pairs of propellers 20-1, 20-2 are preferred not to be partially overlapped when rotating. Similarly, the swept areas (A2) of the rear propellers 20B of the first and second pairs of propellers 20-1, 20-2 are also preferred not to be partially overlapped when rotating.

In one further embodiment, the distance between the rotors 24 of the front propeller 20A and the rear propeller 20B of the first and/or second pairs of the propellers 20-1, 20-2 is preferred to be shorter than the longitudinal length (L) of the body 12 of the UAV 10.

Preferably, the front propeller 20A is arranged at a higher position than the rear propeller 20B relative to the horizontal plane of the body 12. More particularly, the one or more blades 22 of the front propeller 20A is arranged at a distance or height (h) higher than the one or more blades 22 of the rear propeller 20B relative to the horizontal plane of the body 12. Preferably, the height (h) is of less than or equal to about 10% of the swept diameter of the propeller 20, such as the diameter (D1) of the front propeller 20A, or the diameter (D2) of the rear propeller 20B; and more preferably, the height (h) is of about 5% to about 8% of the swept diameter, such as the diameter (D1) of the front propeller 20A, or the diameter (D2) of the rear propeller 20B, for example. Optionally, the rear propeller 20B is preferably tilted slightly downwardly towards the front propeller 20A at the same lateral side. Alternatively, the front propeller 20A may also be configured to tilt slightly downwardly towards the rear propeller 20B at the same lateral side to facilitate the overlapping.

In one embodiment, the front propeller 20A and the rear propeller 20B at the same lateral side are preferred to rotate in opposite directions. More preferably, the two front propellers 20A are also rotated in opposite directions. In another embodiment, the front propellers 20A are configured to rotate at a speed higher than the rear propellers 20B. It is preferred for the front propellers 20A to rotate at a higher rate than the rear propellers 20B because, with the specific configuration of the present invention, the front propellers 20A are found to have a significantly higher efficiency than the rear propellers 20B and therefore, a longer flight time under the same power output of the UAV can be achieved if the front propellers 20A are configured to rotate at a higher speed to thereby produce a larger portion of the required thrust for the flight. This is in contrast to the configuration of conventional UAVs, as each of the multiple propellers in a multi-copters are generally identically configured to contribute equally to the required thrust.

In one further embodiment, the one or more blades 22 of the plurality of propellers 20 are preferred to be pitched.

The specific configuration and the novel combination of features including one or more of the specific ratio or degree of overlapping of blades of two adjacent propellers, the height or separation between the two overlapping blades, the overall length of the propeller or swept diameter relative to the UAV body, as well as spacing between the respective rotors of the propellers are found to produce an advantageous thrust to drag ratio for the UAV and thus, unexpectedly improve or optimize efficiency of the flight. Particularly, the configuration of the UAV of the present invention allows an enhanced lift and stability as provided by the relatively longer blades when compared to configurations of conventional drones or UAVs, without compromising the flight efficiency caused by the air drag due to overlapping of the blades. In contrast to common belief, the current configuration is unexpectedly observed to allow an enhanced performance than the traditional configurations with non-overlapping blades or propellers. The specific configuration further enables a higher thrust or efficiency be achievable at the front propellers than the rear propellers and therefore, by having a higher speed motor at the front propeller, the UAV of the present invention provides a longer flight time under the same power output or battery capacity.

Despite the specific embodiment as shown in the drawings, a person skilled in the art would understand that the present invention shall not be limited to UAVs of any specific number of plurality of propellers and therefore, any multi-copters having such as two, three, five, or six propellers etc. will also be encompassed by the present invention. It is also understandable that the propellers may comprise blades of any other suitable numbers, length, size and/or configurations, and that variations which are considered reasonable or applicable without departing from the inventive concept of the present invention, will also be encompassed.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. An unmanned aerial vehicle (UAV), comprising:
a body; and a plurality of propellers supported by said body; the plurality of propellers being arranged spaced apart from one another, with each of the propellers comprising at least one blade rotatable by a respective rotor; the arrangement being such that swept areas of some of said plurality of propellers partially overlap when the propellers are rotating.

2. The UAV according to claim 1, wherein the plurality of propellers comprise a front propeller arranged adjacent to a front end of the UAV, and a rear propeller arranged adjacent to a rear end of the UAV wherein a swept area (A1) of the front propeller partially overlaps a swept area (A2) of the rear propeller when the front and rear propellers are rotating.

3. The UAV according to claim 2, wherein the front propeller is positioned higher than the rear propeller relative to a horizontal plane of the body.

4. The UAV according to claim 2, wherein the front propeller and the rear propeller are arranged to rotate in opposite directions.

5. The UAV according to claim 2, wherein the UAV is provided with a first pair of propellers comprising a front propeller and a rear propeller arranged on a first side of the UAV and a second pair of propellers comprising a front propeller and a rear propeller arranged on a second side of the UAV.

6. The UAV according to claim 5, wherein the first pair of propellers and the second pair of propellers are symmetrically arranged about a central longitudinal axis of the body, with the rotors of the front propellers of the first and second pairs of propellers being spaced apart by a distance larger than a distance between the rotors of the rear propellers of the first and second pairs of propellers, and/or larger than a distance between the rotors of the front propeller and the rear propeller of one or both of the first and second pairs of propellers.

7. The UAV according to claim 6, wherein the swept areas (A1, A2) of the front and rear propellers of each of the first and second pairs of propellers partially overlap when rotating, but the swept areas (A1) of the front propellers of the first and second pairs of propellers do not partially overlap when rotating and/or the swept areas (A2) of the rear propellers of the first and second pairs of propellers do not partially overlap when rotating.

8. The UAV according to claim 6, wherein the distance between the rotors of the front propellers of the first and second pairs of propellers, and the distance between the rotors of the rear propellers of the first and second pairs of propellers are in a range of ratios of about 10:8 to about 10:9.8.

9. The UAV according to claim 3, wherein the rear propeller is configured to tilt downwardly towards the front propeller or the front propeller is configured to tilt downwardly towards the rear propeller.

10. The UAV according to claim 2, wherein a diameter (D1) of the swept area (A1) of the front propeller overlaps a diameter (D2) of the swept area (A2) of the rear propeller by a distance of less than or equal to about 15% of the diameter (D1) of the swept area (A1) of the front propeller.

11. The UAV according to claim 10, wherein the front propeller and the rear propeller overlap by a distance of less than 10% of the diameter (D1) of the swept area (A1) of the front propeller or the diameter (D2) of the swept area (A2) of the rear propeller.

12. The UAV according to claim 10, wherein the at least one blade of each of the front propeller and the rear propeller comprises two blades connected at their respective rotors, with the two blades together defining the respective swept areas (A1, A2) of the propellers having respective diameters (D1, D2).

13. The UAV according to claim 11, wherein the body of the UAV has a length (L) in a longitudinal direction substantially equal to or less than the diameter (D1) of the swept area (A1) of the front propeller or the diameter (D2) of the swept area (A2) of the rear propeller.

14. The UAV according to claim 10, wherein the at least one blade of the front propeller is positioned at a height (h) above the at least one blade of the rear propeller, with the height (h) being less than or equal to about 10% of the diameter (D1) of the swept area (A1) of the front propeller or of the diameter (D2) of the swept area (A2) of the rear propeller.

15. The UAV according to claim 14, wherein the height (h) is of about 5% to about 8% of the diameter (D1) of the swept area (A1) of the front propeller, or of the diameter (D2) of the swept area of (A2) of the rear propeller.

16. The UAV according to claim 10, wherein the diameter (D1) of the swept area (A1) of the front propeller is of identical length to the diameter (D2) of the swept area (A2) of the rear propeller.

17. The UAV according to claim 2, wherein the front propeller is configured to rotate at a speed higher than the rear propeller.

18. The UAV according to claim 1, wherein the at least one blade of the plurality of propellers are pitched.

19. The UAV according to claim 10, wherein the diameter (D1) of the swept area (A1) of the front propeller, or the diameter (D2) of the swept area (A2) of the rear propeller is of about 25 cm to about 40 cm.

20. The UAV according to claim 2, wherein distance between the rotors of the front propeller and the rear propeller is shorter than a length (L) of the body in a longitudinal direction.
